(19) United States
(12) Patent Application Publication
(10) Pub. No.: US 2023/0335364 A1
(43) Pub. Date: Oct. 19, 2023

(54) ELECTROMAGNETIC RELAY

(71) Applicant: OMRON Corporation, Kyoto-shi (JP)

(72) Inventors: Ayata HORIE, Kyoto-shi (JP); Ryota MINOWA, Kyoto-shi (JP); Kohei OTSUKA, Kyoto-shi (JP)

(21) Appl. No.: 18/131,365

(22) Filed: Apr. 6, 2023

(30) Foreign Application Priority Data
Apr. 13, 2022 (JP) 2022-066325

(51) Int. Cl. H01H 50/36; H01H 50/02; H01H 50/54; H01H 50/64

(52) U.S. Cl. CPC H01H 50/36; H01H 50/02; H01H 50/546; H01H 50/641

(57) ABSTRACT

An electromagnetic relay includes a contact case, a first fixed terminal, a movable contact piece, a magnet and a magnet holding member. The first fixed terminal is held by the contact case. The first fixed terminal includes a first fixed contact. The movable contact piece includes a first movable contact disposed to face the first fixed contact. The magnet is disposed apart from the contact case for generating a magnetic field inside the contact case. The magnet holding member is a separate member from the contact case and holds the magnet.

### CROSS-REFERENCE TO RELATED APPLICATION

This application claims priority to Japanese Patent Application No. 2022-066325, filed Apr. 13, 2022. The contents of that application are incorporated by reference herein in their entirety.

### FIELD

The present invention relates to an electromagnetic relay.

### BACKGROUND

Conventionally, an electromagnetic relay is known that extends and extinguishes an arc generated at a contact using the magnetic force of a magnet. The magnet is held by a holding member configured for holding a fixed terminal (see Japanese Patent Application Laid-Open No. 2013-222560).

### SUMMARY

In the electromagnetic relay of Patent Document 1, the holding member holds the fixed terminal and the magnet. Hence, when the electromagnetic relay receives an impact, the magnet easily vibrates, and the vibration is transmitted to the fixed terminal through the holding member. Any vibration of the magnet transmitted to the fixed terminal may adversely affect the operation of the electromagnetic relay.

An object of the present invention is to provide an electromagnetic relay in which the vibration of a magnet is less likely to be transmitted to a fixed terminal.

An electromagnetic relay according to one aspect of the present invention includes a contact case, a first fixed terminal, a movable contact piece, a magnet, and a magnet holding member. The first fixed terminal is held by the contact case. The first fixed terminal includes a first fixed contact. The movable contact piece includes a first movable contact disposed to face the first fixed contact. The magnet is disposed apart from the contact case and is configured to generate a magnetic field inside the contact case. The magnet holding member is a separate member from the contact case and configured to hold the magnet.

In this electromagnetic relay, the contact case holding the first fixed terminal and the magnet holding member holding the magnet are separate members from each other. Accordingly, as compared to the case where a first fixed terminal and a magnet are held by a common member, less vibration of the magnet is likely to be transmitted to the first fixed terminal.

The electromagnetic relay may further include an outer case disposed outside the contact case. The magnet holding member may be fixed to the outer case. In this case, the outer case may be used to hold the magnet.

The magnet holding member may include a first wall extending from an inner surface of the outer case and a second wall extending from an inner surface of the outer case. The magnet may be sandwiched by the first wall and the second wall. In this case, the magnet can be held with a simple configuration.

The first wall may be disposed between the first fixed terminal and the magnet. In this case, the first wall makes the vibration of the magnet less likely to be transmitted to the first fixed terminal.

The first movable contact may be disposed to face the first fixed contact in a first direction, the first direction including a contact direction in which the first movable contact approaches the first fixed contact and a separation direction in which the first movable contact moves away from the first fixed contact. The magnet may be sandwiched in the first direction by the first wall and the second wall. In this case, the first wall and the second wall make the magnet less likely to move in the first direction.

The magnet holding member may be integral with the outer case. In this case, the number of parts in the electromagnetic relay can be reduced.

The magnet holding member may be disposed apart from the contact case and the first fixed terminal. In this case, less vibration of the magnet is likely to be transmitted to the fixed terminal.

The electromagnetic relay may further include a yoke connected to the magnet. The yoke may be restricted in movement by the magnet holding member. In this case, the magnet holding member limits the movement of the yoke.

The electromagnetic relay may further include a second fixed terminal. The second fixed terminal may be disposed apart from the first fixed terminal. The second fixed terminal may include a second fixed contact. The movable contact piece may further include a second movable contact disposed to face the second fixed contact.

### BRIEF DESCRIPTION OF THE DRAWINGS

FIG. 1 is a cross sectional view of an electromagnetic relay.

FIG. 2 is a diagram illustrating a yoke.

### DETAILED DESCRIPTION

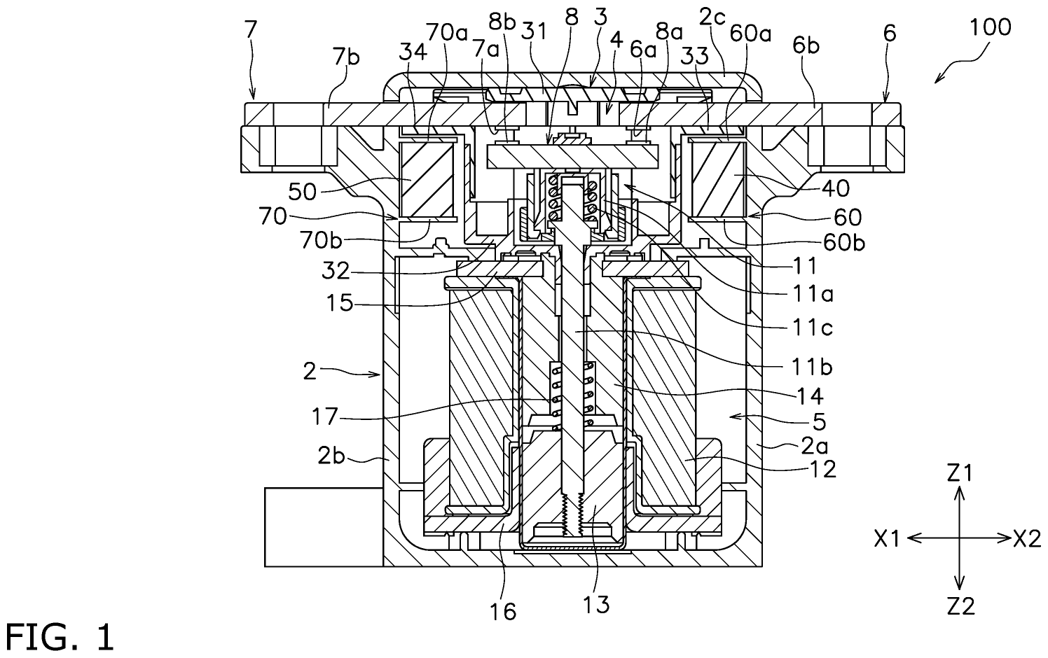

An embodiment of an electromagnetic relay 100 according to one aspect of the present invention will be described below with reference to the drawings. When referring to the drawings, description will be made on the assumption that the X1 direction is the leftward direction, the X2 direction is the rightward direction, the Z1 direction is the upward direction, and the Z2 direction is the downward direction. The front side of the paper surface of FIG. 1 is defined as the front side, and the rear side of the paper surface of FIG. 1 is defined as the rear side. The X1-X2 direction is defined as the left-right direction, the Z1-Z2 direction is defined as the up-down direction, and the direction perpendicular to the plane of FIG. 1 is defined as the front-rear direction. These directions are defined for convenience of description and do not limit the directions of arrangement of the electromagnetic relay 100.

As shown in FIG. 1, the electromagnetic relay 100 includes a case 2, a contact case 3, a contact device 4, and a driving device 5.

The case 2 has a substantially rectangular box shape and is comprised of an insulating material such as resin. The case 2 houses the contact case 3, the contact device 4 and the driving device 5. The case 2 is an example of an outer case.

The contact case 3 is disposed inside the case 2. The contact case 3 is located on the driving device 5. The contact case 3 is a substantially rectangular box in shape and is comprised of an insulating material such as resin.

The contact case 3 includes an upper case 31, a lower case 32, a first terminal support portion 33, and a second terminal support portion 34. The upper case 31 is open downward. The upper case 31 is located on the lower case 32. The upper case 31 is a separate body from the lower case 32. The upper case 31 is fixed to the lower case 32 by, for example, a snap-fitting. The lower case 32 is open upward. The lower case 32 is covered with the upper case 31 from above.

The first terminal support portion 33 and the second terminal support portion 34 are integral with the upper case 31. The first terminal support portion 33 protrudes from the upper case 31 to the right. The first terminal support portion 33 is open rightward. The second terminal support portion 34 protrudes to the left from the upper case 31. The second terminal support portion 34 is open leftward.

The contact device 4 includes a first fixed terminal 6, a second fixed terminal 7, and a movable contact piece 8.

The first fixed terminal 6 and the second fixed terminal 7 are plate-shaped terminals and are made of conductive materials. The first fixed terminal 6 and the second fixed terminal 7 extend in the left-right direction. The first fixed terminal 6 and the second fixed terminal 7 extend across the contact case 3 to the outside. The first fixed terminal 6 and the second fixed terminal 7 are spaced apart from each other in the left-right direction. The first fixed terminal 6 and the second fixed terminal 7 are held by the upper case 31 of the contact case 3.

The first fixed terminal 6 is fixed to the first terminal support portion 33 by press-fitting. The first fixed terminal 6 protrudes from the right wall 2a of the case 2 to the outside. There is provided a gap between the first fixed terminal 6 and the right wall 2a of the case 2, and the first fixed terminal 6 is not fixed to the case 2.

The first fixed terminal 6 includes a first fixed contact 6a and a first external connection portion 6b. The first fixed contact 6a is housed in the contact case 3. The first fixed contact 6a is disposed on the bottom surface of the first fixed terminal 6. The first external connection portion 6b is positioned outside the case 2. The first external connection portion 6b is configured to be connected to an external terminal (not shown) such as a bus bar.

The second fixed terminal 7 is symmetrical to the first fixed terminal 6 in configuration. The second fixed terminal 7 is located to the left of the first fixed terminal 6. The second fixed terminal 7 is fixed to the second terminal support portion 34 by press-fitting. The second fixed terminal 7 protrudes from the left wall 2b of the case 2 to the outside. There is provided a gap between the second fixed terminal 7 and the left wall 2b of the case 2, and the second fixed terminal 7 is not fixed to the case 2.

The second fixed terminal 7 includes a second fixed contact 7a and a second external connection portion 7b. The second fixed contact 7a is housed in contact case 3. The second fixed contact 7a is arranged on the bottom surface of the second fixed terminal 7. The second external connection portion 7b is positioned outside the case 2. The second external connection portion 7b is configured to be connected to an external terminal (not shown) such as a bus bar.

The movable contact piece 8 is housed in the contact case 3. The movable contact piece 8 has a plate shape elongated in one direction and is comprised of a conductive material. The movable contact piece 8 extends in the left-right direction. The movable contact piece 8 is movable in the up-down direction.

The movable contact piece 8 includes a first movable contact 8a and a second movable contact 8b. The first movable contact 8a and the second movable contact 8b are arranged on the top surface of the movable contact piece 8. The first movable contact 8a is arranged to face the first fixed contact 6a in a first direction, the first direction including a contact direction in which the first movable contact 8a approaches the first fixed contact 6a and a separation direction in which the first movable contact 8a moves away from the first fixed contact 6a. In the present embodiment, the up-down direction is an example of a first direction, the upward direction is an example of a contact direction, and the downward direction is an example of a separation direction. The second movable contact 8b is arranged to face the second fixed contact 7a in the up-down direction.

The driving device 5 is disposed inside the case 2. The driving device 5 is configured to move the movable contact piece 8 in the up-down direction. The driving device 5 includes a movable mechanism 11, a coil 12, a movable iron core 13, a fixed iron core 14, yokes 15 and 16, and a return spring 17.

The movable mechanism 11 is coupled to the movable contact piece 8. The movable mechanism 11 includes a holder 11a, a drive shaft 11b, and a contact spring 11c. The holder 11a holds the movable contact piece 8. The holder 11a moves integrally with the movable contact piece 8. The drive shaft 11b extends in the up-down direction. The drive shaft 11b is connected to the holder 11a so as to be movable relative to the holder 11a in the up-down direction. The contact spring 11c is arranged between the holder 11a and the drive shaft 11b. The contact spring 11c urges the movable contact piece 8 upward via the holder 11a.

The coil 12, when excited upon application of a voltage, generates an electromagnetic force to move the movable iron core 13 upward. The movable iron core 13 is fixed to the drive shaft 11b so as to be movable integrally therewith. The fixed iron core 14 is arranged above the movable iron core 13 so as to face the movable iron core 13. The yokes 15 and 16 are arranged to surround the coil 12. The yoke 15 has a substantially U-shape and is connected to the fixed iron core 14. The yoke 16 is arranged below the coil 12 and connected to the yoke 15. The return spring 17 urges the movable iron core 13 downward.

The electromagnetic relay 100 operates in the conventional manner, and only brief description thereof will be given below. FIG. 1 shows a state in which the coil 12 is not energized. In this state, the first movable contact 8a is separated from the first fixed contact 6a, and the second movable contact 8b is separated from the second fixed contact 7a. When the coil 12 is excited, the movable iron core 13 is attracted to the fixed iron core 14 and moves upward together with the drive shaft 11b. As the drive shaft 11b moves, the movable contact piece 8 moves upward via the contact spring 11c, so that the first movable contact 8a contacts the first fixed contact 6a, and the second movable contact 8b contacts the second fixed contact 7a. Upon stop of the voltage application to the coil 12, the return spring 17 urges the drive shaft 11b to move downward together with the movable iron core 13. As a result, the movable contact piece 8 moves downward, the first movable contact 8a moves away from the first fixed contact 6a, and the second movable contact 8b moves away from the second fixed contact 7a.

The electromagnetic relay 100 further includes a first magnet 40, a second magnet 50, a first magnet holding member 60, and a second magnet holding member 70. The first magnet 40 and the second magnet 50 are each an example of a magnet. The first magnet holding member 60 and the second magnet holding member 70 are each an example of a magnet holding member.

The first magnet 40 and the second magnet 50 generate a magnetic field inside the contact case 3. The first magnet 40 and the second magnet 50 are each a permanent magnet. The first magnet 40 and the second magnet 50 each have a cuboid shape.

The first magnet 40 is arranged inside the case 2. The first magnet 40 is disposed apart from the contact case 3. The first magnet 40 is arranged to the right of the contact case 3. The first magnet 40 is positioned below the first fixed terminal 6 and overlaps with the first fixed terminal 6 when viewed from the up-down direction. The first magnet 40 is positioned below the first terminal support portion 33 and overlaps the first terminal support portion 33 when viewed from the up-down direction. The first magnet 40 is held by the first magnet holding member 60.

The second magnet 50 is arranged inside the case 2. The second magnet 50 is disposed apart from the contact case 3. The second magnet 50 is arranged to the left of the contact case 3. The second magnet 50 is arranged to face the first magnet 40 in the left-right direction. The second magnet 50 is arranged below the second fixed terminal 7 and overlaps with the second fixed terminal 7 when viewed from the up-down direction. The second magnet 50 is arranged below the second terminal support portion 34 and overlaps the second terminal support portion 34 when viewed from the up-down direction. The second magnet 50 is held by the second magnet holding member 70.

The first magnet holding member 60 is a separate member from the contact case 3 and holds the first magnet 40. The first magnet holding member 60 is fixed to the case 2. In the present embodiment, the first magnet holding member 60 is integral with the case 2. The first magnet holding member 60 is disposed apart from the contact case 3 and the first fixed terminal 6.

The first magnet holding member 60 includes a first wall 60a and a second wall 60b. The first wall 60a and the second wall 60b extend from an inner surface of case 2. The first wall 60a and the second wall 60b extend leftward from the right wall 2a of the case 2. The first wall 60a and the second wall 60b extend from the right wall 2a of the case 2 towards the right side of the contact case 3.

The first wall 60a is arranged between the first fixed terminal 6 and the first magnet 40. The first wall 60a is arranged between the first terminal support portion 33 and the first magnet 40. The first wall 60a overlaps the first fixed terminal 6 and the first terminal support portion 33 when viewed from the up-down direction. The second wall 60b is arranged to face the first wall 60a in the up-down direction.

The second wall 60b is arranged below the first wall 60a. The second wall 60b is arranged to face the first wall 60a in the up-down direction.

The first magnet 40 is arranged between the first wall 60a and the second wall 60b. The first magnet 40 is sandwiched by the first wall 60a and the second wall 60b in the up-down direction.

The second magnet holding member 70 is symmetrical to the first magnet holding member 60 in configuration. The second magnet holding member 70 is a separate member from the contact case 3 and holds the second magnet 50. The second magnet holding member 70 is fixed to the case 2. In the present embodiment, the second magnet holding member 70 is integral with the case 2. The second magnet holding member 70 is disposed apart from the contact case 3 and the second fixed terminal 7.

The second magnet holding member 70 includes a third wall 70a and a fourth wall 70b. The third wall 70a and the fourth wall 70b extend rightward from the left wall 2b of the case 2. The third wall 70a and the fourth wall 70b extend from the left wall 2b of the case 2 towards the left side of the contact case 3.

The third wall 70a is arranged between the second fixed terminal 7 and the second magnet 50. The third wall 70a is arranged between the second terminal support portion 34 and the second magnet 50. The third wall 70a overlaps the second fixed terminal 7 and the second terminal support portion 34 when viewed from the up-down direction.

The second magnet 50 is arranged between the third wall 70a and the fourth wall 70b. The second magnet 50 is sandwiched by the third wall 70a and the fourth wall 70b in the up-down direction.

In the electromagnetic relay 100, the contact case 3 holding the first fixed terminal 6 and the first magnet holding member 60 holding the first magnet 40 are separate members from each other. Hence, as compared to the case where the first fixed terminal 6 and the first magnet 40 are held by a common member, the vibration of the first magnet 40 becomes less likely to be transmitted to the first fixed terminal 6. That is, the risk can be reduced that the vibration of the first magnet 40 adversely affects the first fixed terminal 6. As a result, less malfunction of the electromagnetic relay 100 will occur. Similarly, since the contact case 3 holding the second fixed terminal 7 and the second magnet holding member 70 holding the second magnet 50 are separate members from each other, the vibration of the second magnet 50 becomes less likely to be transmitted to the second fixed terminal 7.

The first magnet holding member 60 holds the first magnet 40, facilitating keeping of the size of the first magnet 40. As a result, the arc breaking performance can be maintained.

An embodiment of the electromagnetic relay according to one aspect of the present invention have been described above, but the present invention is not limited to the above embodiment, and various modifications are possible without departing from the gist of the invention.

The configuration of the contact case 3 may be changed. The contact case 3 may be composed of a single member. The configuration of the contact device 4 may be changed. For example, the first fixed terminal 6 and the second fixed terminal 7 may be cylindrical. The configuration of the driving device 5 may be changed. The driving device 5 may be configured to push the movable iron core 13 downward. In this case, the movable contact piece 8 is arranged above the first fixed terminal 6 and the second fixed terminal 7.

The configuration of first magnet holding member 60 may be changed. The first magnet holding member 60 may be a member separate from the case 2. The first magnet holding member 60 may be comprised of a material different from that of the case 2. The first magnet holding member 60 may be fixed to a member different from the case 2. The first magnet holding member 60 may have a structure into which the first magnet 40 is press-fitted. The first magnet holding member 60 may have a structure that sandwiches the first magnet 40 in the front-rear direction. For example, the first wall 60a and the second wall 60b may be arranged to face each other in the front-rear direction.

The first magnet holding member 60 should have only a structure capable of holding the first magnet 40. That is, a structure to limit the movement of the first magnet 40 is only what is requested for the first magnet holding member 60. For example, the first magnet holding member 60 may have a protrusion for restricting forward and backward movement of the first magnet 40 and/or a protrusion for restricting leftward movement of the first magnet 40.

In the above embodiment, the first wall 60a is arranged on the right wall 2a of the case 2, but the first wall 60a may be arranged on the upper wall 2c of the case 2. The first wall 60a may be arranged across the right wall 2a of the case 2 and the upper wall 2c of the case 2. Note that the upper wall 2c of the case 2 and the right wall 2a of the case 2 may be separate members from each other. The first wall 60a and the second wall 60b may be arranged on the front wall (not shown) of the case 2 or the rear wall (not shown) of the case 2.

The position of the first magnet 40 may be changed. The first magnet 40 may be applied to an electromagnetic relay of the present invention in which the first magnet 40 is arranged in front or behind the contact case 3. For example, when the first magnet 40 is positioned in front of the contact case 3, the first magnet holding member 60 may be disposed on the front wall of the case 2.

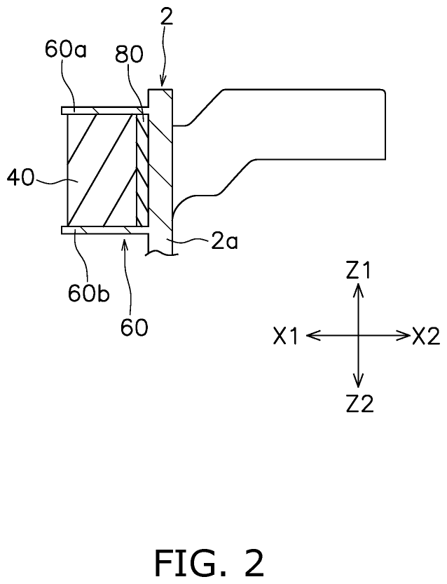

The electromagnetic relay 100 may further comprise a yoke 80, as shown in FIG. 2. The yoke 80 extends in the left-right direction and is connected to the first magnet 40 and the second magnet 50. In this case, the yoke 80 may be held by the first magnet holding member 60. Alternatively, the yoke 80 may be restricted in movement by the first magnet holding member 60. Specifically, the yoke 80 may be partially positioned between the first wall 60a and the second wall 60b of the first magnet holding member 60. The yoke 80 may be restricted in movement in the up-down direction by the first wall 60a and the second wall 60b. The yoke 80 may be sandwiched by the first wall 60a and the second wall 60b in the up-down direction. Similarly, the yoke 80 may be held by the second magnet holding member 70 or may be restricted in movement by the second magnet holding member 70.

### REFERENCE NUMERALS

2 Case (Example of outer case)
3 Contact case
6 First fixed terminal
6a First fixed contact
7 Second fixed terminal
7a Second fixed contact
40 First magnet (Example of magnet)
60 First magnet holding member (Example of magnet holding member)
60a First wall
60b Second wall
80 Yoke
100 Electromagnetic relay

1. An electromagnetic relay, comprising:
a contact case;
a first fixed terminal including a first fixed contact and held by the contact case;
a movable contact piece including a first movable contact disposed to face the first fixed contact;
a magnet disposed apart from the contact case, the magnet being configured to generate a magnetic field inside the contact case; and
a magnet holding member configure to hold the magnet, the magnet holding member being a separate member from the contact case.

2. The electromagnetic relay according to claim 1, further comprising:
an outer case disposed outside the contact case, wherein
the magnet holding member is fixed to the outer case.

3. The electromagnetic relay according to claim 2, wherein
the magnet holding member includes a first wall extending from an inner surface of the outer case and a second wall extending from an inner surface of the outer case, and
the magnet is sandwiched between the first wall and the second wall.

4. The electromagnetic relay according to claim 3, wherein
the first wall is disposed between the first fixed terminal and the magnet.

5. The electromagnetic relay according to claim 3, wherein
the first movable contact is disposed to face the first fixed contact in a first direction, the first direction including a contact direction in which the first movable contact approaches the first fixed contact and a separation direction in which the first movable contact moves away from the first fixed contact, and
the magnet is sandwiched in the first direction by the first wall and the second wall.

6. The electromagnetic relay according to claim 2, wherein
the magnet holding member is integral with the outer case.

7. The electromagnetic relay according to claim 2, wherein
the magnet holding member is disposed apart from the contact case and the first fixed terminal.

8. The electromagnetic relay according to claim 1, further comprising:
a yoke connected to the magnet, wherein
the yoke is restricted in movement by the magnet holding member.

9. The electromagnetic relay according to claim 1, further comprising:
a second fixed terminal disposed apart from the first fixed terminal, the second fixed terminal including a second fixed contact, wherein
the movable contact piece further includes a second movable contact disposed to face the second fixed contact.
